(19) United States
(12) Patent Application Publication
(10) Pub. No.: US 2015/0141885 A1
(43) Pub. Date: May 21, 2015

(54) Hand-Held Massage Device

(71) Applicant: Dan Marcum, Kirbyville, TX (US)

(72) Inventor: Dan Marcum, Kirbyville, TX (US)

(21) Appl. No.: 14/546,096

(22) Filed: Nov. 18, 2014

Related U.S. Application Data
(60) Provisional application No. 61/905,389, filed on Nov. 18, 2013.

(51) Int. Cl. A61H 15/00

(52) U.S. Cl. CPC A61H 15/0092; A61H 2201/0107
USPC 601/112

(57) ABSTRACT

Described is a massage tool for use with animals or humans, and particularly adapted for use with horses. The tool includes an elongated bar that can be linear or curved. The elongated bar has a first end and a second end, wherein each end includes a massage member thereon. The massage members include rotating wheels, spherical members, or forked members. The wheels may be disposed such that they are perpendicular to or in line with the elongated bar. The elongated bar may include one or more handles thereon to help the user to hold the massage tool in a desired orientation. The user can hold the massage tool in order to move the massage members on a human or animal.

### CROSS REFERENCE TO RELATED APPLICATION

This application claims the benefit of U.S. Provisional Application No. 61/905,389 filed on Nov. 18, 2013. The above identified patent application is herein incorporated by reference in its entirety to provide continuity of disclosure.

### BACKGROUND OF THE INVENTION

1. Field of the Invention

The present invention relates to a massage device. More specifically, the present invention provides a massage device for animals or humans, and that is particularly adapted for use with horses, comprising an elongated bar with one or more massage members thereon. The massage members can comprise rotating wheels, spherical members, forked members, or other similar massaging structures.

Horses are exercised on a regular basis to ensure their fitness and health. However, horses may develop muscle stiffness, muscle strains, or other pain. If a horse suffers from a muscular injury, the horse's performance may be negatively affected, and the horse's overall demeanor may change. Such muscular injuries require prompt treatment to prevent the horse from exacerbating the injury, and to allow the horse to stay in good health.

An owner may massage a horse's muscles in order to help relieve tension to prevent the horse from injuring the muscle. However, it may be difficult for the horse owner to apply sufficient pressure using his or her hands alone. Further, it may be difficult for the user to massage or soothe specific muscles on the horse's body. Thus, a device is required to help a user apply pressure and massage a horse in various ways.

The present invention provides a massage tool for use with animals or humans, and that is particularly suited for use with horses. The massage tool comprises an elongated bar that can be curved or linear in configuration. The elongated bar includes a first end and a second end. One or both of the ends can include a massage member thereon. The massage member may include a rotating wheel, a spherical member, or a forked member, among others. The elongated bar may include one or more handles along the length thereof. The handles help a user to hold the massage tool in a desired orientation to help the user manipulate the massage tool. The user can hold the massage tool and move the massage members over a human or animal's body to help relieve muscle pains and tension.

2. Description of the Prior Art

Devices have been disclosed in the prior art that relate to massage devices. These include devices that have been patented and published in patent application publications. These devices generally relate to hand-held or manually operated massaging tools for humans or animals. The following is a list of devices deemed most relevant to the present disclosure, which are herein described for the purposes of highlighting and differentiating the unique aspects of the present invention, and further highlighting the drawbacks existing in the prior art.

One such device, U.S. Pat. No. 3,831,592 to Lancellotti discloses a trigger point instrument adapted for use in releasing trigger points on the human body. The device includes an elongated handle having a pair of legs extending therefrom. The spacing between the pair of legs is adjustable so that the user may increase or decrease the separation between the legs. The legs further include resilient tips thereon. Thus, Lancellotti disclose a trigger point instrument but fails to disclose a massage tool having massage members such as a rotatable wheel, a spherical member, or a forked member.

U.S. Pat. No. 7,137,960 to Tien discloses a massaging device. The massaging device includes a shank having a cavity in a first end and a pair of legs on the second end. A stub is positioned within the first end and is used for pressing points on a user's body. A ball is positioned in the free end of each leg and the balls are adapted to rotate along a user's body. The shank further includes a fin thereon. Thus, while Tien discloses a massaging device, Tien fails to disclose a massage device having rotatable wheels or forked massage members thereon.

U.S. Published Patent Application Number 2008/0086066 to Munday discloses a pressure point massage system for personal use. The massage system includes a pair of rigid structural members having a plurality of massage mounts thereon. The structural members are connected by a chain-like connector having a releasable link that permits separation of the structural members. Massage elements are removably connected to the massage mounts. Thus, Munday does not disclose an elongated bar having massage members on the ends thereof, and fails to disclose a massage device that can be held and manually manipulated by a user to massage another user or an animal.

U.S. Published Patent Application Number 2011/0174234 to Friberg et al. discloses an animal treatment device. The device includes a treatment member having a first and second end, a longitudinal axis, and a driving member. The treatment device rotates about the longitudinal axis by means of the driving member. A carrying member supports the treatment and driving members, and an anchor member secures the carrying member to a stationary element or surface. Thus, Friberg et al. discloses an animal treatment device that is securable to a fixed structure and does not include a hand operated massage tool having various massage members thereon.

Finally, U.S. Pat. No. 6,102,876 to Winger discloses a hand held massaging device. The device includes a rod with movable elements thereon and having a pair of contacts on opposite ends of the rod. The contact elements can engage a body of a user in various ways and the contacts can be held by the user. While Winger discloses a hand held massage device, Winger does not disclose a massage tool having rotatable wheels on the ends of an elongated rod.

These prior art devices have several known drawbacks. Devices in the prior art relate to massaging devices of various construction. Such devices only provide one type of massage member so that the device can only be used in one way. The present invention provides a massage tool having different massage members that the user can use to massage various portions of a human or animal and that can be used in different ways. Thus, the present invention provides a versatile massaging tool that is hand-operated.

In light of the devices disclosed in the prior art, it is submitted that the present invention substantially diverges in design elements from the prior art and consequently it is clear that there is a need in the art for an improvement to existing massage tool devices. In this regard the instant invention substantially fulfills these needs.

### SUMMARY OF THE INVENTION

In view of the foregoing disadvantages inherent in the known types of hand-held massage devices now present in the prior art, the present invention provides a new hand-held massage device wherein the same can be utilized for providing convenience for the user when massaging another user or an animal using a hand-held device.

It is therefore an object of the present invention to provide a new and improved hand-held massage device that has all of the advantages of the prior art and none of the disadvantages.

It is another object of the present invention to provide a hand-held massage tool comprising an elongated bar with one or more massage members thereon.

Another object of the present invention is to provide a hand-held massage tool having rotatable wheels thereon.

Yet another object of the present invention is to provide a hand-held massage tool having various types of massage members thereon, such as a spherical ball or a forked member, among others.

Another object of the present invention is to provide a hand-held massage tool that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the massage tool of the present invention.

FIG. 2 shows a perspective view of another embodiment of the massage tool of the present invention.

FIG. 3 shows a perspective view of an additional embodiment of the massage tool of the present invention.

### DETAILED DESCRIPTION OF THE INVENTION

Reference is made herein to the attached drawings. Like reference numerals are used throughout the drawings to depict like or similar elements of the hand-held massage tool. For the purposes of presenting a brief and clear description of the present invention, the preferred embodiment will be discussed as used for massaging a human or animal. The figures are intended for representative purposes only and should not be considered to be limiting in any respect.

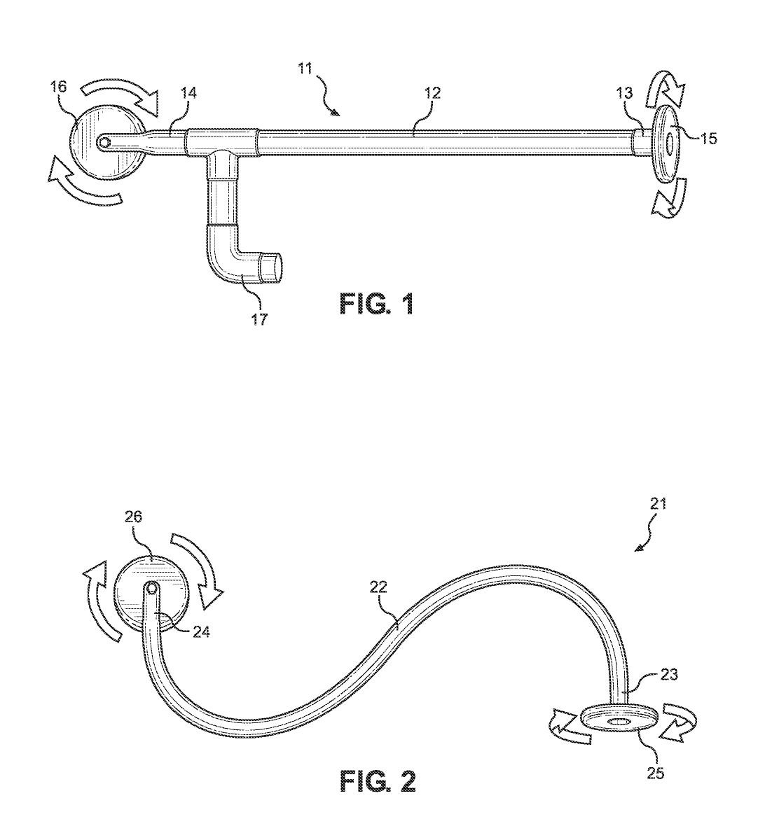

Referring now to FIG. 1, there is shown a perspective view of an embodiment of the massage tool of the present invention. The massage tool 11 of the present invention includes an elongated bar 12 having a first end 13 and a second end 14. The elongated bar 12 is preferably tubular and includes a circular cross section. The elongated bar 12 may be composed of hard plastic, metal, wood, or other lightweight and durable materials. The elongated bar 12 includes one or more massage members thereon, wherein each massage member is located at the first end 13 or second end 14 of the elongated bar 12. The massage members may variously include rotatable wheels, spherical members, or forked members, among others. Further, the massage tool 11 comprises one or more handles 17 on the elongated bar 12 that help a user to hold and manipulate the massage tool 11.

In the illustrated embodiment, the elongated bar 12 is substantially linear in configuration. A first end 13 includes a first massage member thereon. The first massage member includes a rotatable wheel 15 mounted perpendicularly with respect to the longitudinal axis of the elongated bar 12. The wheel 15 rotates about an axle disposed on the first end 13 of the elongated bar. The second end 14 of the elongated bar includes a second massage member thereon. The second massage member includes a rotatable wheel 16 mounted in-line with the axis of the elongated bar 12. The wheel 16 is disposed on an axle supported by the second end 14 of the elongated bar 12, wherein the axle is perpendicular to the longitudinal axis of the elongated bar 12. Thus, the first and second ends 13, 14 of the elongated bar include different types of massage members that allows a user to select which massage member to use in massaging a human or animal.

Massage members comprising wheels allow a user to break up muscle spasms and unreleased muscle contractions on a human or animal. The user can roll the wheel or wheels across the grain fibers of the muscle to break up muscle spasms, or the user may roll the muscle along the length of the grain fibers of the muscles in order to break up muscle spasms. The rolling motion may also help to stretch the muscle.

In the illustrated embodiment, the elongated bar 12 further includes a handle 17 thereon. The handle 17 allows a user to better grasp and hold the massage tool 11 so that the user can move the massage members along the body of a human or animal in order to help relieve stress and tension. The handle 17 may include a linear bar that extends outward from the elongated bar 12. Preferably, the handle 17 is perpendicular to the elongated bar 12. Alternatively, the handle 17 may include an L-shaped bar that extends outward from the elongated bar 12.

Referring now to FIG. 2, there is shown a perspective view of another embodiment of the massage tool of the present invention. In the illustrated embodiment, the massage tool 21 comprises an elongated bar 22 having an arcuate shape. The elongated bar 22 includes a first end 23 and a second end 24. Each of the first end 23 and second end 24 includes a massage member thereon. The first end 23 includes a rotatable wheel 25 thereon. The wheel 25 is perpendicular to the first end 23 of the elongated bar 22. The wheel 25 is disposed on an axle mounted on the first end 23 of the elongated bar 22. Additionally, the second end 24 includes a rotatable wheel 26 thereon. The rotatable wheel 26 is positioned in-line with the second end 24 of the elongated bar 22. The rotatable wheel 26 is supported on an axle on the second end 24 of the elongated bar 12.

The illustrated embodiment of the massage tool 21 is suitable for use by an individual who wishes to massage his or her own back. The arcuate elongated bar 22 serves as a handle for the user to hold. The user can position a curved portion over his or her shoulder so that a wheel 25, 26 rests against his or her back. In this way, the user can manipulate the massage tool 21 so that the massage tool can be used to massage the user's back by rolling the wheels 25, 26 against the user's back.

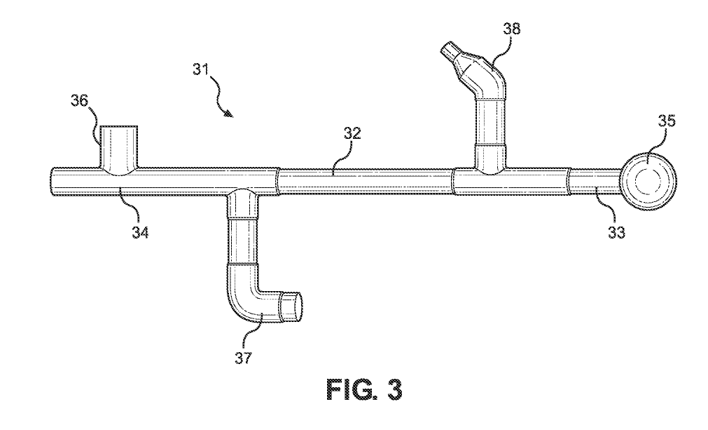

Referring now to FIG. 3, there is shown a perspective view of an additional embodiment of the massage tool of the present invention. In the illustrated embodiment, the massage tool 31 comprises alternative types of massage members thereon. The elongated bar 32 is substantially linear and includes a first end 33 and a second end 34. The first end 33 includes a spherical member 35 thereon. The spherical member 35 is rigidly affixed to the first end 33 of the elongated bar 32. The second end 34 includes a forked member 36 thereon. The forked member 36 can be used to apply pressure to a human or animal in order to perform stress point therapy. For example, the forked member 36 can be placed on the extensor and flexor muscles of a front leg of a horse so that the user can simultaneously massage two muscle groups at once. The forked member 36 can be used to massage other areas and muscle groups on a human or animal.

The elongated bar 32 further includes a first handle 37 thereon and a tapered massage member 38. The first handle 37 extends perpendicularly outward from the elongated bar 32. The first handle 37 comprises an L-shape, but may alternately include various other configurations. The first handle 37 may comprise a circular cross section having a diameter that is constant over its length or that varies over its length. In embodiments wherein the first handle 37 varies in diameter over its length, the user can have a narrow or a wide grip when holding the massage tool of the present invention. Preferably, where two or more handles are provided, the handles are disposed at different positions along the length of the elongated bar 32 so that the user can place his or her hands on different locations along the length of the elongated bar 32. Further, the handles are disposed on opposing sides of the elongated bar 32 so that one handle extends from an upper portion of the elongated bar 32 while another extends from a lower portion thereof.

The tapered massage member 38 is disposed on a linear bar that extends perpendicularly outward from the elongated bar 32. The linear bar can serve as an additional handle for a user to hold while massaging a human or animal. The end of the linear member includes a tapered massage member 38 thereon that comprises an angled configuration. The tapered massage member 38 is cylindrical and tapers to form a cylinder of smaller diameter than that of the linear bar. The tapered massage member 38 is specifically adapted to perform stress point therapy on the occipital mandibular muscle on a horse, generally located between the atlas and mandible of a horse. The shape of the tapered massage member 38 allows a user to press the massage member onto the occipital mandibular muscle which is not readily accessed using other types of massage members. The tapered massage member 38 can additionally be used to perform stress point therapy on other muscle groups on a human or animal.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A massage tool, comprising:
an elongated bar having a first end and a second end;
wherein at least one of said first end or said second end includes a massage member thereon.

2. The massage tool of claim 1, further comprising
one or more handles disposed on said elongated bar.

3. The massage tool of claim 2, wherein said one or more handles comprise an L-shape.

4. The massage tool of claim 2, wherein said one or more handles are perpendicular to said elongated bar.

5. The massage tool of claim 1, wherein said massage member comprises a rotatable wheel.

6. The massage tool of claim 5, where said rotatable wheel is perpendicular to said elongated bar.

7. The massage tool of claim 5, wherein said rotatable wheel is in line with said elongated bar.

8. The massage tool of claim 1, wherein said massage member comprises a spherical member.

9. The massage tool of claim 1, wherein said massage member comprises a forked member.

10. The massage tool of claim 1, wherein said elongated bar is substantially linear.

11. The massage tool of claim 1, wherein said elongated bar is arcuate.

12. A massage tool, comprising:
an elongated bar having a first end and a second end;
wherein said elongated bar is substantially linear;
a first massage member disposed on said first end of said elongated bar;
a second massage member disposed on said second end of said elongated bar;
one or more handles extending from said elongated bar.

13. The massage tool of claim 12, wherein at least one of said first massage member and said second massage member is a rotatable wheel.

14. The massage tool of claim 12, wherein said first massage member comprises a spherical ball and wherein said second massage member comprises a forked member.

15. The massage tool of claim 12, wherein at least one of said one or more handles comprises an L-shape.

16. The massage tool of claim 12, wherein at least one of said one or more handles comprises a circular cross section with a diameter that varies over its length.
